(19) United States
(12) Patent Application Publication
(10) Pub. No.: US 2009/0125918 A1
(43) Pub. Date: May 14, 2009

(54) SHARED SENSING SYSTEM INTERFACES

(75) Inventors: Aman Kansal, Issaquah, WA (US); Suman Kumar Nath, Redmond, WA (US); Jie Liu, Sammamish, WA (US); Feng Zhao, Issaquah, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/939,404

(22) Filed: Nov. 13, 2007

(51) Int. Cl. G06F 9/54

(52) U.S. Cl. 719/328

(57) ABSTRACT

Various interfaces such as application programming interfaces (APIs) are employed to allow developers to construct applications that use multiple shared sensors. In one instance, a coordinator can be utilized to facilitate coordination of sensor data contributors and applications desirous of utilizing such data. Standardized interfaces can be employed to aid interaction between all entities including contributors, applications and a coordinator, amongst others.

### BACKGROUND

Sensors are devices that monitor and/or detect real-world conditions. In general, sensors are a type of transducer that operate by converting energy of one form to another. There are several conventional categories of sensors delineated as a function of the energy they detect including thermal, mechanical, optical, and acoustic, among others. For example, thermometers measure temperature, barometers gauge pressure, proximity sensors detect distance, microphones sense sound, and cameras capture images. Other simple and complex sensor categories also exist such as those related to location. For instance, radio frequency identification (RFID) or global positioning satellite (GPS) systems may be employed to pinpoint a geographical location of an entity.

Software applications acquire data from sensors or a network of sensors to provide useful functionality. By way of example, applications exist for provisioning weather information for a particular location. Upon receipt of the query, a local weather station or set of one or more sensors can be identified and interrogated by an application to enable presentation of requested weather information. In another instance, a sports application can annotate a runner's GPS trace with plurality of sensor data such as heart rate and altitude.

In one implementation, applications can be tightly coupled with sensor networks. In other words, the sensors can be deployed specifically for use by an application. For example, scientists may deploy sensors designated for monitoring streams, soil moister, seismic waves, or the like. Dedicated applications can acquire sensor data from associated sensors for monitoring and/or processing, among other things.

Additionally or alternatively, sensors can be shared and employed by particular applications. In one instance, individuals share weather sensors from their home weather stations to enable large-scale weather forecasts to be provided. As another example, information from hikers' GPS enabled body worn sensors can be shared to help others choose appropriate trails for their fitness level. In these systems, system sensor owners upload their data, which is then made available through application specific graphical user interfaces.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to shared sensing interfaces. A system can allow multiple sensors or sensor networks (e.g., shared or dedicated) to be deployed for specific applications to be shared or leveraged for developing new applications or deploying existing applications in new areas. Interactions amongst heterogeneous data sources and consumers are enabled herein by a plurality of interfaces such as application programming interfaces (APIs). Furthermore, the interfaces can be common or standardized to facilitate interaction.

In accordance with one aspect of the disclosure, an interface is provided between a coordinator of sensor data and one or more applications that utilize such data. The interface enables applications to share sensing resources contributed by several entities in a flexible yet uniform manner. In furtherance thereof, similar interfaces are also disclosed with respect to collecting and/or provisioning sensor data to the coordinator.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of sensor interaction system in accordance with an aspect of the disclosure.

FIG. 2 is a block diagram of a representative application-coordinator interface component according to a disclosed aspect.

FIG. 3 is a block diagram of a sensor recordation systems in accordance with an aspect of the disclosed subject matter

FIG. 4 is a block diagram or a representative coordinator-contributor interface component according to an aspect of the disclosure.

FIG. 5 is a block diagram of a contributor system in accordance with an aspect of the disclosure.

FIG. 6 is a block diagram of a representative contributor-gateway interface component according to an aspect of the subject disclosure.

FIG. 7 is a block diagram of a gateway system according to an aspect of the subject disclosure.

FIG. 8 is a block diagram of a representative gateway-sensor interface in accordance with an aspect of the disclosure.

FIG. 9 is a flow chart diagram of a method of communication between an application and a coordinator in accordance with an aspect of the disclosure.

FIG. 10 is a flow chart diagram of a method of a coordinator contributor communication according to an aspect of the disclosed subject matter.

FIG. 11 is a flow chart diagram of a method of communication amongst a contributor and a gateway in accordance with an aspect of the disclosure.

FIG. 12 is a flow chart diagram of a method of communication between a gateway and one or more sensors according to an aspect of the disclosure.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods are described hereinafter pertaining to shared sensor system interfaces. Various interfaces are provided that allow developers to write applications against a plurality of shared sensors, among other things. Common interfaces can be employed to facilitate interaction with different sensors without requiring a plethora of diverse interfaces. Interfaces can be positioned between an application and a coordinator, a coordinator and a contributor, a coordinator and a gateway and/or a gateway and a sensor.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

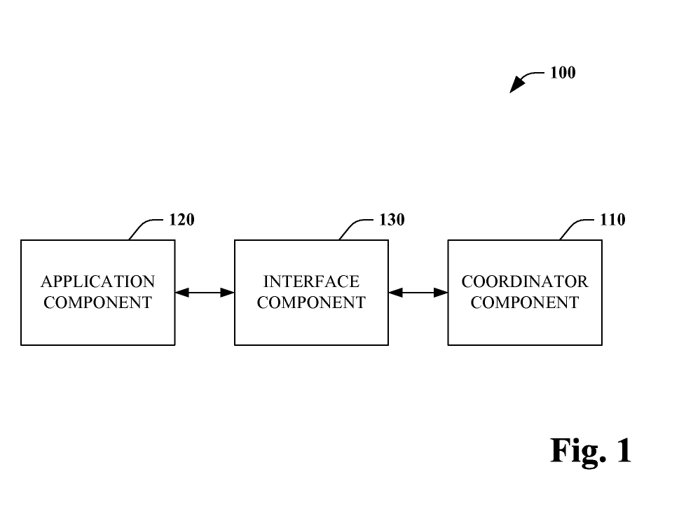

Referring initially to FIG. 1, a sensor interaction system 100 is illustrated in accordance with an aspect of the claimed subject matter. As shown, the system 100 includes a coordinator component 110 that facilitates sharing of sensor data. In one instance, the coordinator component 110 provides a central access point for identifying available sensors, collecting data from the sensors, and provisioning data to entities such as application component 120. Application component 120 can correspond to any hardware, software, or combination thereof that seeks to utilize one or more sensors. These applications can be interactive applications where human users specify their data needs manually (e.g. user queries). Additionally or alternatively, applications can be automated in backend systems that access sensor streams for processing. For example, an inventory management application can access shopper volume from parking counters or customer behavior from video streams and correlate them with sales records.

While individuals can share sensors for specific applications such as weather forecasting, such conventional applications reveal only a small portion of benefits offered by shared sensing. In particular, applications can be built to leverage data from sensors already available in other deployed systems. For instance, if a retailer with several outlets at shopping malls across a nation could access video streams from security cameras at those malls, the retailer could build custom business applications for understanding customer behavior. Additionally, data collection can also be configured for needs of specific sensing applications. For example, if a rainstorm hits, a cab dispatch system could automatically request images of flooded road segments from commuters with cell phone-cameras, security cameras, and/or traffic cameras, among others. In general, applications can initiate and access sensor data streams from shared sensor data across the Internet, for instance. The coordinator component 110 can enable efficient sharing of sensing resources contributed by several entities amongst one or more application components 120.

Sharing multiple sensors or sensor networks for deploying new applications or deploying existing applications in new areas is very useful since it leverages available sensing infrastructure for multiple tasks. However, one issue that makes it difficult to employ multiple sensors is that conventionally each sensor may employ its own interface or in some instances not even include an interface to allow usage thereof. Accordingly, a common system can be employed through which multiple sensors can be shared.

The coordinator component 110 provides a central entity that coordinates applications with sensor contributors and provides services to identify information about sensors and collect data from them. A common or standard interface component 130 facilitates interaction between the coordinator component 110 and the application component 120. In this manner, different components need not be utilized for different sensors to be used by the application component 110. The interface component 130 thus provides access to sensing functionality across all available sensors.

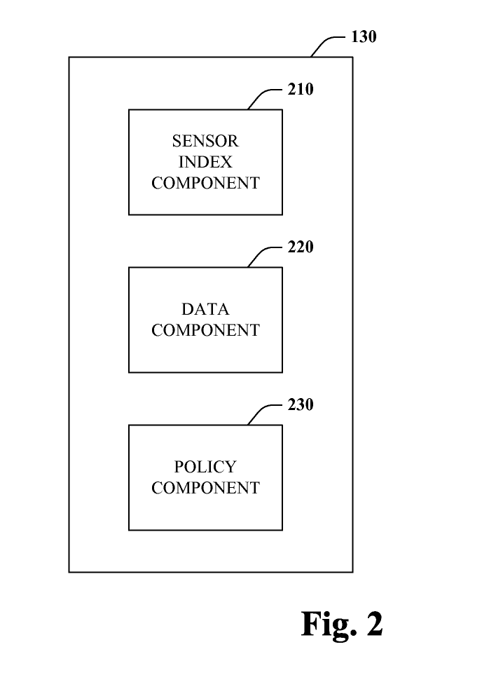

FIG. 2 depicts a representative interface component 130 in accordance with one aspect of the claimed subject matter. The interface component 130 facilitates interaction between one or more applications and a coordinator. Applications access the coordinator for various functions, such as discovering sensors of interest to them, and collecting data from those sensors. To discover sensors, an application may specify the geographic region of interest, a time window during which the sensors should be or should have been available, and the sensor characteristics of interest (e.g., sensed metric, quality of sensor, cost of usage . . . ). To obtain sensor data, applications can submit requests or queries to the coordinator via the interface component 130. Requests fall into three general categories those pertaining to sensors, sensor data and sensing policy, which are supported by sensor index component 210, data component 220, and policy component 230, respectively.

The sensor index component 210 receives requests and provisions information relating to one or more sensors of interest. Sensors can be identified in a variety of ways. In one instance, sensors can be identified by specifying one or more sensor ids. Alternatively, location can be employed to identify sensors of interest. For instance, a spatial polygon or route can be utilized to identify a set of one or more sensors in an area. In practice, it is to be noted that an application can first seek a list of all sensors by an approximate polygon and then explicitly specify particular sensors for inquiry. In response to a request, the sensor index component 210 can return a list of one or more sensors in a variety of formats. Further, sensor information can include but is not limited to publisher name, sensor name, location (e.g. latitude and longitude), sensor type (e.g. temperature, pressure, traffic . . . ), units (e.g., Celsius, Fahrenheit), URL (Uniform Resource Locator), key words, description, data type (e.g., binary, scalar, vector . . . ), sampling period, report period, and entry time.

The data component 220 receives queries and provides sensor data in response to the queries. The results can be raw sensor data or processed data. For example, aggregation functions can be applied such as sum, average, minimum, maximum, combinations, or more sophisticated aggregation. The data component 220 can also provide event processing. For instance, image data can be processed to detect changed fraction or temperature data can be subject to a threshold (return temperatures greater than one hundred degrees).

In one implementation, the processing is specified as a directed acyclic graph (DAG) with sensor values as leaf nodes and processing blocks as intermediate and root nodes. The processing DAG is executed each time data is updated at a leaf node. Data at leaf nodes may be updated at sampling rate or a lower rate (e.g., when some event processing is carried out at the sensor, the sensor experiences disconnections . . . ). A parser can also be employed that that translates a query expressed in structured query language (SQL) like syntax to the DAG specification to facilitate query specification.

The policy component 230 enables configuration of a sampling rate and/or report rate for an application. Further, the application can specify whether all data generated is maintained on a store or overwritten after every report rate period. If the all query result data over a time window is maintained, an application can fetch the data at its leisure including during or after the query has been executed. The drawback is that if an application does indeed regularly download data at its desired report rate, it ends up downloading repeated old data each time. If the data is refreshed every report rate, the application should download the data every report rate or it may be lost. An expiry time for storage of the data generated in response to a query may be enforced by the coordinator to conserve resources. Expired data may be discarded or dumped into an archival database.

The interface component 130 can be embodied as an application programming interface (API) or implementation thereof in accordance with an aspect of the claimed subject matter. An API or set of APIs can be exposed by the coordinator component 110 (FIG. 1) as a means for requesting service from the coordinator component 110. Applications can request service utilizing specific function or method calls provided by an API. In accordance with an aspect of the claimed subject matter, a common or standard API is proposed to facilitate access to access to sensor data by a number of different applications. Provided below are a few exemplary API calls that can be employed to effect interface component 310 functionality described above.

GetDataByLocationTime is a call that helps collect data from a set of sensors that satisfy a specified location and time window. The location window can be specified as a polygon (e.g. represented by a set of points) or a route (e.g., a polyline represented with a set of points and a route width). The time window can be specified by an even number of time points representing time durations during which sensor data is needed.

An example C# implementation of the GetDataByLocationTime call interface is provided below.

public SensorInfo[ ] GetDataByLocationTime (int numPoints, string
csvPoints, string timeWindow, string searchStr, string sensorTypes)

Here, the method call returns a list of SensorInfo objects where each object in the list describes one sensor each. The argument numPoints is an integer that specifies how many points are used to represent polygon. The argument csvPoints is a string that lists the points used to describe the polygon (e.g., latitude and longitude values). The string time Window lists two time instances that describe a time window of interest. The string searchStr includes text to be searched within sensor characteristics. For example, sensors that include certain key words (e.g., “good quality,” “free,” “New York” . . . ) can be selected filtered out. The string sensorTypes lists what types of sensors (e.g. “temperature,” “pressure,” “camera” . . . ) that are of interest.

Other calls can include: (1) GetDataBySensorIDs; (2) GetAggregateDataByLocationTime; (3) GetAggregatedDataBySensorIDs; (4) GetSensorsByLocationTime, and (5) GetSensorDescriptionBySensorID. The GetDataBySensorIDs call allows an application to acquire details about a sensor such as their location and accuracy, among other things, utilizing a known sensor id. The GetAggregateDataByLocationTime call enables data to be collected from a location and time of interest and an aggregation function applied such as taking an average or other application specific processing. The GetAggregatedDataBySensorIDs call provides the same functionality as GetAggregateDataByLocationTime except sensors of interest are specified by identifiers. The GetSensorsByLocationTime call helps discover sensors of interest by specifying a location of interest and optionally a time window during which the sensors are expected to be or have been available.

In response to any of the above calls, the coordinator component 110 can provide an application with a list of sensors and/or data collected by sensors. The list of sensors can include one or more sensor information objects. Data is returned as binary, scalar or vector value for each sample taken by a sensor. When multiple sensors or time instances are relevant, multiple sensor values can be returned marked with their location and time instance or sensor id depending on the method used to collect data.

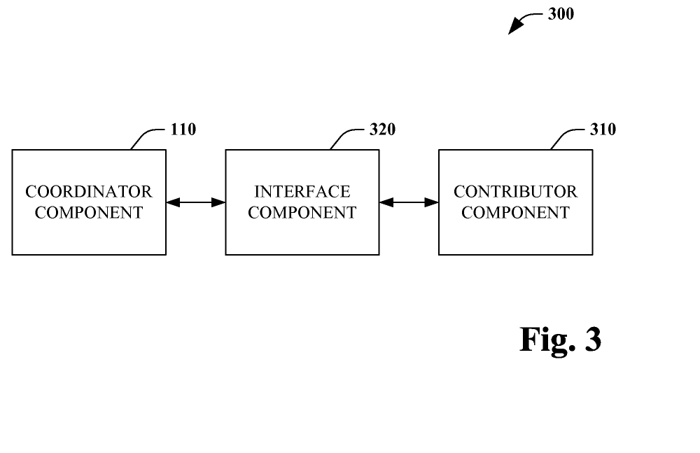

Turning attention to FIG. 3, a sensor recordation system 300 is illustrated in accordance with an aspect of the claimed subject matter. System 300 includes a coordinator component 110 as previously described with respect to FIG. 1. In brief, the coordinator component 110 facilitates sharing of sensing resources with applications in a uniform manner. Prior to providing sensor resources, the coordinator component 110 needs to be made aware of sensors. Contributor component 310 refers to any entity that wishes to make one or more sensors known to the coordinator component 110 to make them available to applications as needed. In one instance, the contributor component 310 can be a network service or sensor itself but is not limited thereto. The coordinator component 110 and contributor component 310 can communicate with each other utilizing interface component 320. Similar to interface component 130, the interface component 320 can be standardized or common to enable easy provisioning of sensor resources to coordinator component 110 by multiple contributor components 310.

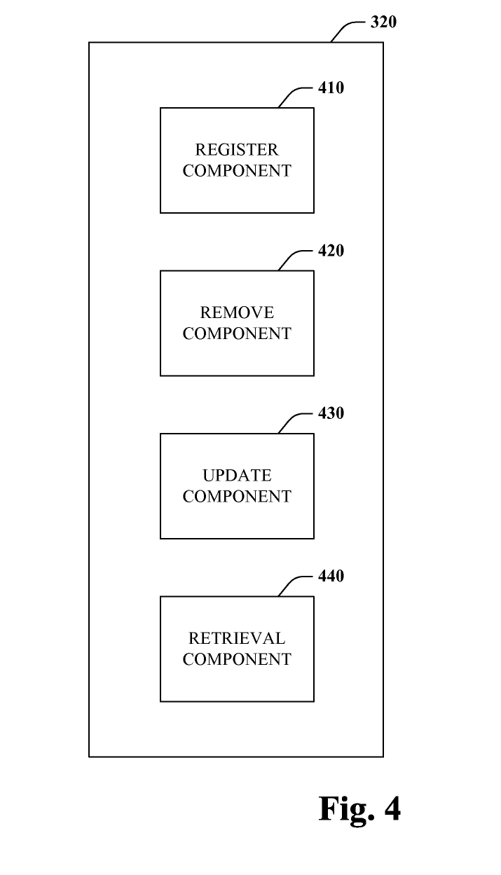

FIG. 4 depicts a representative interface component 320 in accordance with an aspect of the claimed subject matter. The interface component 320 includes a registration component 410 for registering a sensor to make it known to the coordinator. The registration component 410 can also make various sensor characteristics known. Remove component 420 is a mechanism to remove a previously registered sensor from a coordinator for example if it is no longer available or becomes private. Update component 430 enables parameters of a registered sensor to be updated or otherwise modified. For example, location of a sensor can be updated where the sensor is moved. Additionally or alternatively, sensor direction (e.g., instead of north a camera is now pointing south) and availability (e.g. previously free sensor now charging a fee) can be updated. Retrieval component 440 is a mechanism allowing a contributor to acquire information from a coordinator. For example, a contributor may like to view all sensors it has registered with a coordinator. Additionally, the retrieval component 440 can allow a contributor to acquire ongoing sensing or data collection task to determine if it is able to contribute.

In accordance with an aspect of the claimed subject matter, the interface component 320 can be embodied as an API provided by a coordinator component 110 (or alternatively contributor component 310). A few exemplary API calls that enable at least a portion of interface component 320 functionality are provided below with respect to Table 1.

TABLE 1

| Call | Description |
|---|---|
| RegisterSensor | Makes a sensor known to the coordinator |
| | along with sensor characteristics of |
| | interest |
| RemoveSensor | Removes a previously registered sensor |
| UpdateSensorLocation | Changes the location characteristic of |
| | a sensor |
| UpdateSensorCharacteristic | Changes the characteristics of a |
| | registered sensor |
| GetAllSensorsByContributor | Returns a list of all sensors registered |
| | by a single contributor |
| GetSensingTasks | Allows a contributor to download |
| | ongoing sensing or data collection tasks |
| | to which it can contribute |

In accordance with one exemplary implementation, the contributor component 310 can describe a sensor as an object as follows:

```
Object SensorInfo
{
    public string publisherName;
    public string sensorName;
    public double longitude;
    public double latitude;
    public double altitude;
    public string unit;
    public string sensorType;
    public usageContraint sensorUsers{
        public string userName;
        public string availability;
    }
    public string url;
    public string keywords;
    public string description;
    public string dataType;
    public double samplingPeriod;
    public double reportPeriod;
    public DateTime entryTime;
    public static string UniqueSensorID(string sensorName, string
    publisherName)
    {
        return sensorName + “_” + publisherName.Replace(‘@’,
‘.’);
    }
}
```

Some of the above fields can be omitted in describing a sensor such as when some information is not available or withheld for privacy. Note also that the above description can also be specified in other programming languages and represented in XML (eXtensible Markup Language) or other decriptions. An example XML representation of the sensorInfo object, is shown below, where the XML tag “Sensor” is used to represent SensorInfo objects and appropriate tags are defined for various other attributes of the object:

```
<?xml version=“1.0” encoding=“utf-8”?>
<Sensor>
    <publisherName>string</publisherName>
    <publisherID>string</publisherID>
    <sensorName>string</sensorName>
    <longitude>double</longitude>
    <latitude>double</latitude>
    <altitude>double</altitude>
    <unit>string</unit>
    <sensorType>string</sensorType>
    <url>string</url>
    <keywords>string</keywords>
    <description>string</description>
    <dataType>string</dataType>
    <samplingPeriod>double</samplingPeriod>
    <reportPeriod>double</reportPeriod>
    <entryTime>dateTime</entryTime>
</Sensor>
```

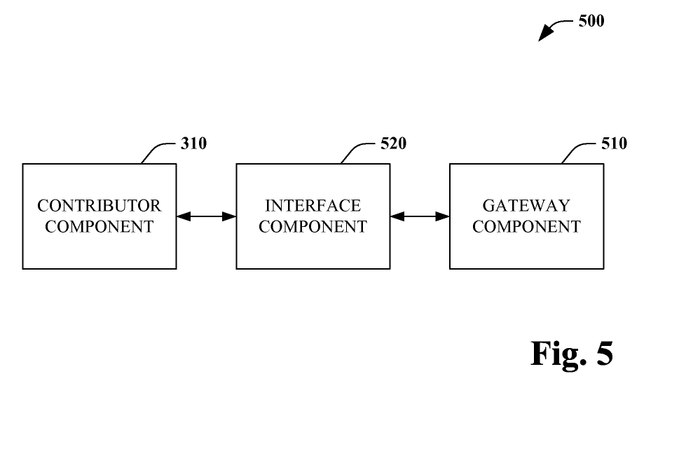

Referring to FIG. 5, a contributor system 500 is illustrated in accordance with an aspect of the claimed subject matter. The system 500 includes a contributor component 310 as previously described. Also included is a gateway component 510 communicatively coupled by interface component 520 to the contributor component 310. In one embodiment the contributor component 310 can correspond to sensors themselves. In another embodiment, the contributor component 310 can maintain a sensor gateway or use a gateway provided by another entity, such as the entity that maintains the coordinator. In this instance, the gateway component 510 is responsible for connecting sensors to a coordinator component 110 (FIG. 1) via contributor component 310. The interface component 520 enables the contributor component 310 to fetch or receive data from sensors served by gateway component 510.

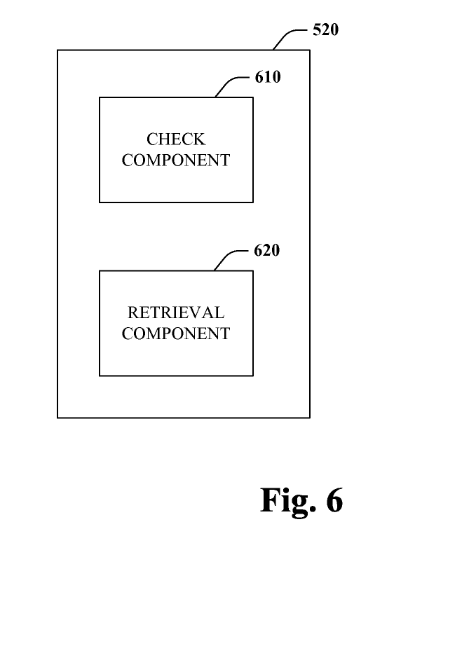

FIG. 6 depicts a representative interface component 520 in accordance with an aspect of the claimed subject matter. As shown the interface component can include a check component 610 and a retrieval component 620. The check component 610 enables checking if a sensor has newer data than a given time. This is helpful in ensuring that current data is acquired from a sensor.

The retrieval component 620 enables a contributor to acquire data among other things from sensors. In one instance, the retrieval component 620 can acquire scalar data. Scalar data corresponds to a single number value such as thirty as in thirty degrees Fahrenheit. In another instance, the retrieval component 620 can obtain vector data. Vector data is a set of numbers. For example, a weather station could return three numbers corresponding to temperature, pressure, and humidity. Further yet, the retrieval component can acquire binary data. Binary data can include data associated with images among other things.

The retrieval component 620 can enable data to be retrieved in many different ways. For example, data can be acquired by referencing a sensor id. Alternatively, a time window can be employed to acquire data between two time points such as between 9 a.m. today and 9 a.m. tomorrow.

Furthermore, the retrieval component 620 can acquire processed data. Data processing can be specified in conjunction with a retrieval request. Subsequently processing can be performed in accordance therewith and the resulting data returned. In one instance, processing can be performed to detect a specified event. For example, data from a temperature sensor can be requested only when temperature is greater than a threshold value (e.g. 30 degrees—indicative of freezing or 150 degrees—indicative of a fire).

In addition to data acquisition, the retrieval component 620 can also acquire the latest time at which sensor has taken a measurement. For example, the most recent time an image has been taken by a camera.

In one implementation, the interface component 520 can be an API. For instance, the gateway component 510 can provide an API to enable the contributor component 310 to acquire sensor data from the gateway component 510. A few exemplary API calls and descriptions are provided below with respect to Table 2.

TABLE 2

| Call | Description |
|---|---|
| IsDataYoungerThan | Allows checking if a sensor has recent |
| | data newer than required time |
| GetLatestScalarData | Obtains the latest scalar value from a |
| | sensor |
| GetLatestBinaryData | Obtains the latest binary value from a |
| | sensor |
| GetLatestVectorData | Obtains the latest vector data from a |
| | sensor |
| GetLatestSensingTime | Obtains the recent sampling instance at |
| | which the recent sensor reading was taken. |
| GetDataByTimeWindow | Acquire data from a sensor collected |
| | within a specified time window |
| GetProcessedData(EventSpec) | Allows specifying what processing should |
| | be performed on data after collection |
| | (processing may be limited by methods |
| | provided by the gateway) |

It is to be noted that some contributors may develop gateways that provide a URL for accessing data from each sensor. The data can subsequently be accessed by fetching the URL. The format of data stored at the URL can be HTML, image, geoRSS, or custom XML, among others.

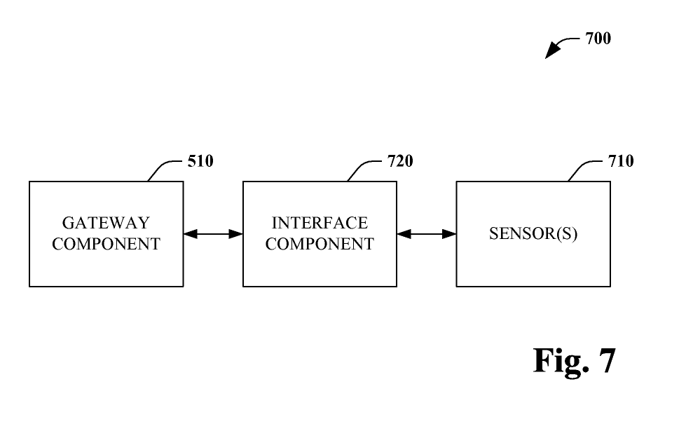

Turning attention to FIG. 7, a gateway system 700 is illustrated in accordance with an aspect of the claimed subject matter. The system includes a gateway component 510, as previously described, sensors 710 and an interface 720 to enable communication between the gateway component 510 and the sensors 710. The gateway system 700 is utilized when a coordinator does not interact with sensors directly but rather through a gateway.

Because contributors can build sensors using many different platforms that vary in power, energy, and bandwidth capabilities, the sensors might have different interfaces to access them. Low-powered wireless sensor nodes can use ZigBee radios to communicate while higher power and higher bandwidth sensors might need Firewire or similar interfaces. Further, the sensors might or might not be connected at all times. For example, battery operated sensors may only be connected part time.

To hide much of this complexity, sensors can be connected to a sensor gateway component 510 that provides a uniform interface to components above it. Each sensor contributor might maintain his or her own gateway. The gateway might also implement sharing policies defined by the contributor. For instance the gateway might maintain all raw data in its local database—possibly for local applications the sensor owner runs—but only make certain non-privacy sensitive parts of the data or data at lower sampling rates available for use by a sensor community.

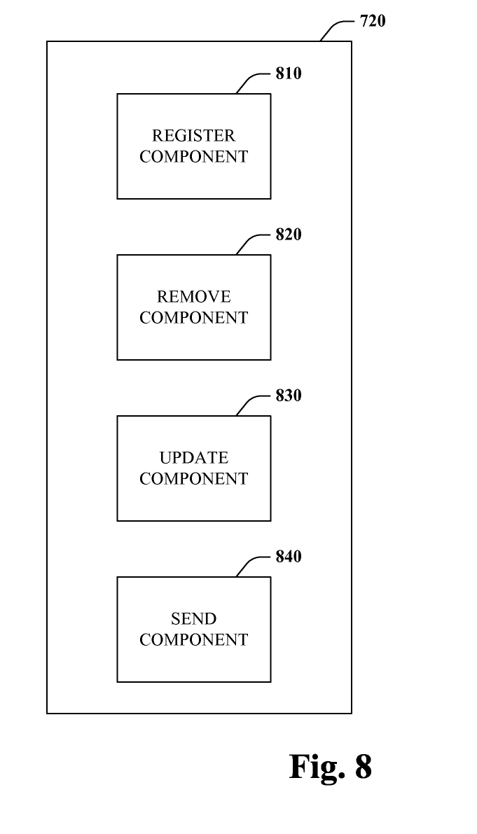

Referring to FIG. 8, a representative interface component 720 is illustrated in accordance with an aspect of the claimed subject matter. The interface component 720 similar to the coordinator-contributor interface component 320 (FIG. 4) can include mechanism to make a gateway aware of sensors. In particular, the interface component 720 can include a register component 810 to enable sensors to register themselves with a gateway component 510. Registered sensors can be later removed or unregistered from the gateway utilizing remove component 820, for example, where a sensor is no longer available or a public sensor becomes private. The interface component 720 can also include an update component to change sensor parameters or characteristics. It is to be noted that specific or popular changes such as location may have dedicated components to aid usage. Further yet, the interface component 720 can include a send component to enable sensors to send data (e.g., scalar, vector, binary).

In one embodiment, the interface component 710 can be an API offered by the gateway component 510, for instance. It is useful to provide a common API used by many sensors that share a common gateway. This API may be provided over the Internet, a local area network (LAN), universal serial bus (USB), Zigbee, WiFi, or other customer sensor interface as chosen by the developer of the gateway. This API can allow sensors to provide registration information, data and download event-detecting code, among other things. Exemplary API method of function calls capturing at least a portion of related functionality provided above are provided in Table 3 below.

TABLE 3

| Call | Description |
|---|---|
| RegisterSensor | Register a sensor |
| RemoveSensor | Remove/un-register a sensor |
| UpdateSensorCharacteristic | Change attribute describing a sensor |
| UpdateSensorLocation | Change location of a sensor. |
| SendVectorData | Send a set of scalar values as a vector |
| SendBinaryData | Send binary data such as image, sound, or |
| | video. All data can be treated as binary. |
| SendScalarData | Send scalar data. Array data can be |
| | encoded as comma-separated values. |

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, interfaces or other components can employ such mechanisms to push or pull sensor data automatically.

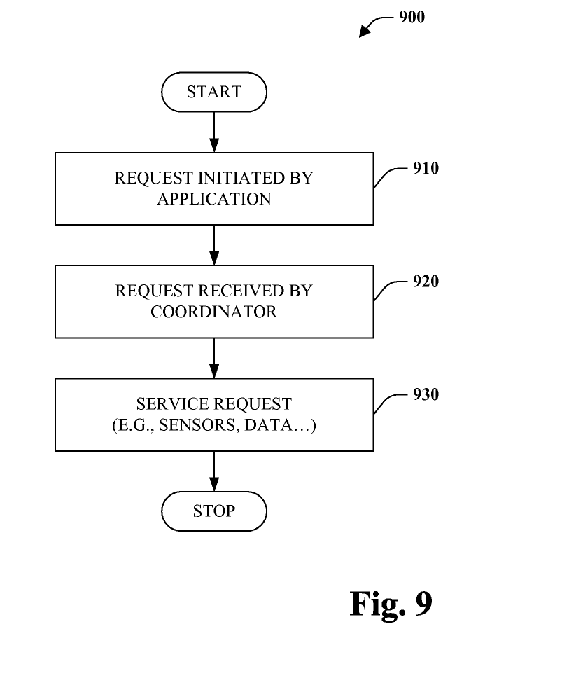

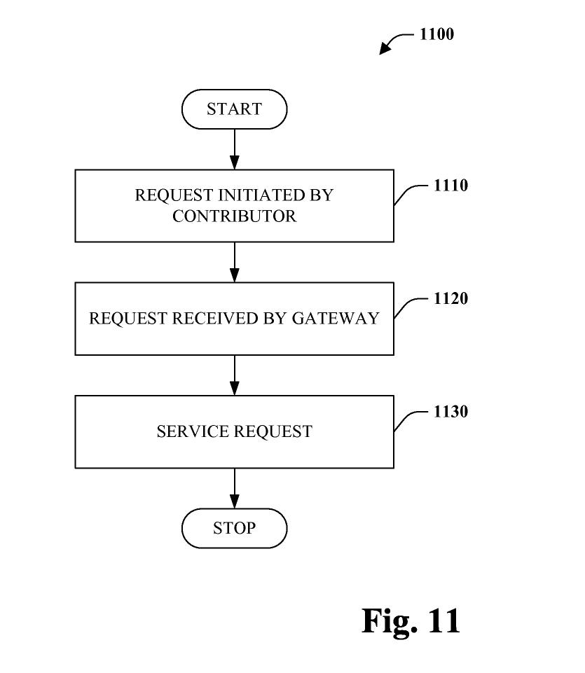

In view of the exemplary systems described supra, methodologies that may be implemented in accordance with the disclosed subject matter will be better appreciated with reference to the flow charts of FIGS. 9-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a communication method between an application and a coordinator 900 is depicted in accordance with an aspect of the claimed subject matter. At reference numeral 910, a request or query is received from an application. In this case, an application is a user of sensor data and the request pertains thereto. The request is received by a coordinator at 920. The coordinator can correspond to a central entity for coordinating sharing of sensor resources with one or more applications. The received request is serviced at numeral 930. Depending on the request, service can correspond to returning sensors identified by id or location and/or time, providing sensor data, and/or provisioning of sensor data. For example, a coordinator can provide an application with a list of sensors and data collected by the sensors. In accordance with on aspect of the claimed subject matter, the communication method 900 can be common or standardized to enable multiple applications to easily share sensing resources. In one embodiment, the method 900 can be embodied by one or more common APIs provided by the coordinator, for instance, for acquiring sensors, sensor information, data, and/or configuration of sampling and/or report rates, among other things.

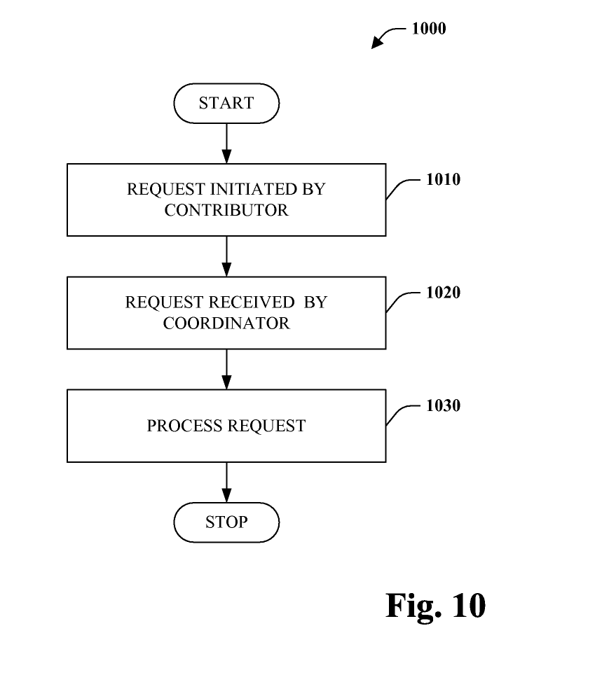

FIG. 10 is a method of communicating between a coordinator and a contributor 1000 according to an aspect of the claimed subject matter. At reference numeral 1010, a request is initiated by a contributor or provider of sensor or other data. The request is received by a data coordinator at 1020. The service is subsequently processed at numeral 1030. As previously described, the coordinator provides easy access to data by applications. However, coordination requires knowledge of sensors or other data supplies. Consequently, the coordinator and contributors need to communicate. In accordance with one aspect of the claims, this method can be embodied as an API or set of APIs for provided by the coordinator, for instance, to enable contributors to make coordinators aware of available sensors, among other things. For example, the API can enable registration of sensors with the coordinator, update of registered sensor characteristics, retrieval of sensor tasks, and/or retrieval of sensors registered by a contributor, inter alia.

FIG. 1100 is a flow chart diagram of a method of communication 1100 amongst a contributor and a gateway in accordance with an aspect of the claimed subject matter. In some instances, a contributor can utilize one or more gateways to provide a uniform interface for a plurality of sensors or other like devices rather than interact with sensors directly. Consequently, the contributor and gateway need to communicate enable sensor information to be passed. Method 1100 provides one means of communication.

At reference numeral 1110, a request is initiated by a contributor for sensor related data and/or information, among other things. The request can be received by a gateway at numeral 1120 and serviced thereby at reference 1130. For example, a gateway component provision sensor data (e.g., raw or processed) or other information such as the most recent time data has been retrieved from a sensor in response to requests. In one instance, the method 1100 can be embodied as one or more APIs provided by a gateway wherein a set of functions and/or methods are made available for calling by the contributor.

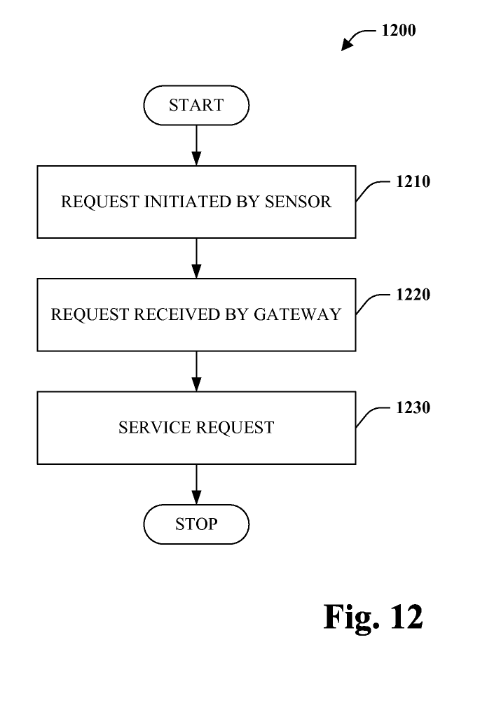

Referring to FIG. 12, a method of communicating between a gateway and one or more sensors 1200 is depicted in accordance with an aspect of the claimed subject matter. At reference numeral 1210, a request is initiated by a sensor. The requested request is received or otherwise acquired by a gateway at numeral 1220. The request is then serviced by the gateway at reference 1230. In one instance, the request can pertain to registration of a sensor with a gateway. Another request can modify or update a registration or characteristics of registered sensors in light of a change (e.g., sensor location moved, sensor usage changed from free to fee . . . ). Yet another request can concern provisioning of sensor data to the gateway. In accordance with one embodiment, the method can be implemented as an API. Accordingly, the gateway can expose a common set of functions or methods to sensors to enable interaction.

It is to be noted that methods 900-1200 are described with respect to a particular implementation. However, the claimed subject matter is not limited thereto. In particular, methods are described based an implementation in which one of the two communication partners are the source of the interface or expose an API. However, the claimed subject matter is not limited by the source of the interface and contemplates reversal of roles. For example, method 1100 is described in terms of an interface provided by a gateway. Nevertheless, the contributor can be the source of the interface such that data is received by the contributor rather than pulled from the gateway. Similarly, method 1200 describes an implementation wherein sensors interact with a gateway. However, a gateway can alternatively interact with sensors where sensors expose an API, for instance.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

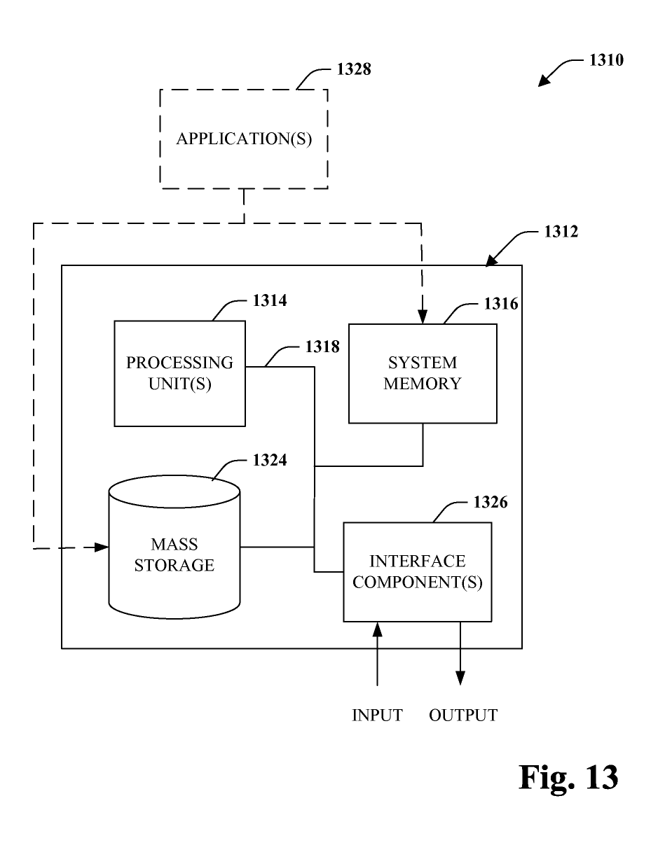

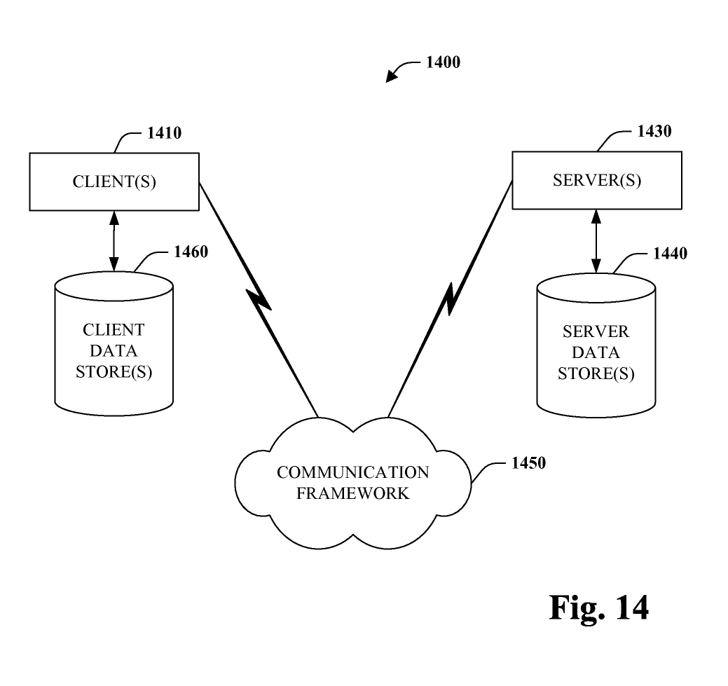

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory, or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g. CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

Client/server interactions can be utilized with respect with respect to various aspects of the claimed subject matter. For example, applications can be clients 1410 of a coordinator server 1430 that provisions sensor related information acquired directly from sensor resources and/or server data store 1440 over the communication framework 1450. Further yet, the interface components provided herein can be embodied as network services (e.g., Web or Internet services) resident on one or more servers 1430 for use by clients 1410 including applications, coordinators, contributors, gateways and sensors.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system to facilitate sensor interaction, comprising:
a coordinator component that acquires and maintains sensor data contributed by a plurality of entities; and
an interface component that facilitates interaction between the coordinator and an application that utilizes the sensor data.

2. The system of claim 1, further comprising a sensor index component to facilitate discovery of sensors of interest.

3. The system of claim 1, further comprising a data component to facilitate identification of desired sensor data for acquisition.

4. The system of claim 3, sensors from which data is acquired are identified by location, time, or sensor id.

5. The system of claim 3, data processing is specified for execution on the data prior to acquisition.

6. The system of claim 5, the processing is data aggregation including sum, average, maximum, and/or minimum.

7. The system of claim 1, further comprising a component to specify data sampling and/or report rates.

8. The system of claim 1, the interface component is a standardized interface to the coordinator component.

9. A method of communicating between a sensor contributor and a coordinator of sensed data, comprising:
issuing a request, by a contributor, to register a sensor;
receiving the request, by a coordinator of sensed data; and
registering the sensor with the coordinator.

10. The method of claim 9, further comprising:
issuing a request, by the contributor, to remove the sensor;
receiving the request by the coordinator; and
removing the sensor registration.

11. The method of claim 9, further comprising
issuing a request, by the contributor, to update sensor characteristics;
receiving the request by the coordinator; and
updating sensor characteristics.

12. The method of claim 11, comprising issuing a request to update a sensor location.

13. The method of claim 9, further comprising:
issuing a request, by the contributor, for sensors registered by an identified contributor;
receiving the request by the coordinator; and
returning a list of all sensors registered by the identified contributor.

14. The method of claim 9, further comprising:
issuing a request, by the contributor, for sensing tasks;
receiving the request by the coordinator; and
returning the sensing tasks.

15. The method of claim 9, issuing a request by a gateway.

16. A method of interaction between a gateway and a sensor, comprising:
receiving, by a gateway, a request issued from a sensor to register the sensor; and
registering the sensor with the gateway.

17. The method of claim 16, further comprising receiving data from the sensor.

18. The method of claim 17, receiving binary data, scalar data or vector data.

19. The method of claim 16, further comprising:
receiving, by the gateway, a request issued from the sensor to updated the sensor; and
updating characteristics of the sensor in accordance with the request.

20. The method of claim 16, further comprising:
receiving, by the gateway, a request issued from the sensor to remove the sensor; and
removing registration of the sensor.
